(19) United States
(12) Patent Application Publication
(10) Pub. No.: US 2013/0313228 A1
(43) Pub. Date: Nov. 28, 2013

(54) SWITCH WITH QUENCHING CHAMBER

(71) Applicants: Lutz Friedrichsen, Cologne (DE); Volker Lang, Bonn (DE)

(72) Inventors: Lutz Friedrichsen, Cologne (DE); Volker Lang, Bonn (DE)

(73) Assignee: EATON ELECTRICAL IP GMBH & CO. KG, Schoenefeld (DE)

(21) Appl. No.: 13/992,278

(22) PCT Filed: Dec. 7, 2011
(86) PCT No.: PCT/EP2011/072092

§ 371 Date: Jul. 19, 2013

(30) Foreign Application Priority Data
Dec. 7, 2010 (EP) 10194006.2

(51) Int. Cl. H01H 33/18

(52) U.S. Cl. CPC H01H 33/182
USPC 218/23

(57) ABSTRACT

A switch for polarity-independent direct current operation includes fixed contacts, each including a first contact area. A movable bridge contact with second contact areas is configured to form an electrically conducting connection between the contact areas in an ON state and to separate the contact areas in an OFF state. A magnetic field exerts a magnetic force on an arc occurring between the contact areas when the OFF state is generated. Quenching chambers are provided to quench arcs with a first current direction. A first arc deflector plate extends from each of the quenching chambers toward the first contact area and a second arc deflector plate extends toward the second contact area for removing the arc into the quenching chambers. Each movable bridge contact includes two bridge plates which extend around each of the first contact areas so as to quench arcs in a second direction.

### CROSS REFERENCE TO RELATED APPLICATIONS

This application is a U.S. National Phase application under 35 U.S.C. §371 of International Application No. PCT/EP2011/072092, filed on Dec. 7, 2011, and claims benefit to European Patent Application No. EP 10194006.2, filed on Dec. 7, 2010. The International Application was published in German on Jun. 14, 2012, as WO 2012/076603 A1 under PCT Article 21 (2).

### FIELD

The invention relates to switches with quenching chambers for quickly quenching an arc during the switch opening procedure

### BACKGROUND

Electrical switches are components in a circuit which create (switch state “ON” or ON state) or break (switch state “OFF” or “OFF” state) an electrically conductive connection by means of internal, electrically conductive contacts. In the case of a current-carrying connection that is to be broken, current flows through the contacts until these are separated. If an inductive current circuit through a switch is broken, the flowing current cannot directly go to zero. In this case, an arc forms between the contacts. This arc is a gas discharge through a non-conductive medium such as e.g. air. Arcs in switches in alternating current (AC) service are extinguished during the zero crossing of the alternating current at the latest. Due to the lack of a zero crossing of the current, stable burning arcs occur in switches in direct current (DC) service, so long as the arc voltage is distinctly smaller than the operating voltage, when contacts are separated (switching off). If the circuit is operated with sufficient current and voltage (typically at more than 1 A and more than 50V), the arc will not extinguish itself. To this end, quenching chambers are employed in such switches for quenching the arc. The arcing time (time during which the arc is burning) must be kept as low as possible, as the arc releases a large quantity of heat which leads to burnout of the contacts and/or thermal loading of the bridge device in the switch, and thus shortens the lifetime of the switch. It is consequently necessary for this arc to be quickly quenched.

As a rule, quenching of the arc is accelerated by the use of a magnetic field that is polarized so that a driving force is exerted on the arc in the direction of the quenching chamber. Here, the magnitude of the driving force depends on the strength of the magnet or magnets. Customarily, permanent magnets are used to generate a strong magnetic field. Unfortunately, the driving force of the magnetic field in the direction of the quenching chamber only occurs when the current flows in a particular direction. In order to prevent switch installation errors due to polarity or if switches are needed for both current directions, switches having a quick quenching process for arcs occurring between the open contacts during opening of the switch, that is independent of the respective polarity, would be desirable.

### SUMMARY

In an embodiment, the present invention provides a switch for polarity-independent direct current operation includes at least two separated fixed contacts, each including a first contact area. A movable electrically conductive bridge contact with two second contact areas is configured to form an electrically conducting connection between the first and second contact areas in an ON state of the switch and to separate the first and second contact areas in an OFF state of the switch. A magnet is configured to generate a substantially constant magnetic field in a region of the first and second contact areas so as to exert a magnetic force on an arc occurring between the first and second contact areas when the OFF sate is generated. At least two first quenching chambers are provided to quench arcs with a first current direction. A first arc deflector plate extends, at least in the OFF state, from each of the first quenching chambers toward the first contact area and a second arc deflector plate extends toward the second contact area for removing the arc into the first quenching chambers. The movable bridge contact includes first and second bridge plates which extend around each of the first contact areas to a back side of the fixed contacts facing away from the bridge contact, so as to quench arcs in a second direction opposite that of the first current direction from the bridge contact along a displacement axis of the bridge contact.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a cross-section through an embodiment of a switching chamber of a switch according to the present invention;

FIG. 2 shows an enlarged cross-section from FIG. 1 for one half of the switching chamber of the switch; and

FIG. 3 shows a cross-section through another embodiment of a switching chamber of a switch according to the present invention.

### DETAILED DESCRIPTION

An aspect of the present invention is to provide a switch which overcomes the aforementioned disadvantages of the prior art.

In an embodiment, the present invention provides a switch suitable for direct current operation independent of polarity, with at least two separate fixed contacts each with one first contact area at least one movable electrically conductive bridge contact with two second contact areas for generating an electrically conductive connection between the first and second contact areas in the ON state of the switch and for separating the first and second contact areas in the OFF state of the switch, with at least one magnet suitable for generating a substantially constant magnetic field in the area of the first and second contact areas for exerting a magnetic force on an arc occurring between the first and second contact areas during generation of the OFF state, with two first quenching chambers for quenching the arc having a first current direction, one first arc deflector extending from each of the first quenching chambers toward the first contact area, at least on the OFF state, and a second arc deflector extending toward the second contact area for deflecting the arc into the first quenching chambers, and the movable bridge contact including two bridge plates which, for the purpose of quenching the arc, extend in a second direction opposite that of the first current direction from the bridge contact along the displacement axis of the bridge contact, around each of the first contact areas to the back sides of the fixed contacts facing away from the bridge contact. Here the expression, “the movable bridge contact including two bridge plates” also indicates the possibility that the bridge contact and the bridge plates are indirectly interconnected through the bridge device. Here the bridge device designates the device to which the bridge contact is movably fixed, for example by means of a spring and a guide in a suitably formed bridge device made of plastic. Here the bridge plates also constitute a thermal protection for the bridge device.

A switch according to an embodiment of the present invention includes all types of single- or multi-pole switches having at least two fixed contacts which can be electrically closed by at least one movable bridge contact. Examples of these switches are protective switches, load-break switches or circuit breakers. Here the switch is suited for direct current operation, but could also be used in alternating current service. Polarity-dependent direct current operation designates the operation of the switch in a direct current circuit, the arc in the switch being quickly quenched regardless of the direction of the current. Here, arcs can occur between the first and the second contact areas, wherein the current can flow from the first to the second contact area or the reverse. As the substantially constant magnetic field with a fixed direction (predefined by the installation of the magnets in the switch) always, given a fixed current direction, drives the arc in a fixed direction determined by the Lorenz force, additional measures for quick quenching of the arc must be found for operation of the switch in the other current direction (second current direction in the arc), which is accomplished by embodiments of the present invention by means of the bridge plates and their special arrangement. The bridge plate operates here as a cooling plate for the arc. The advantage of the claimed arrangement is the simple, symmetrical and consequently cost-effective construction of the switch. The stronger the magnetic field is at the location of the arc, the quicker the arc will be driven into the quenching chamber or along the bridge plate and thus quenched. In a preferred arrangement of the magnets in the switch, the arc switch between one of the first and second contact areas is driven into the corresponding first quenching chamber and the arc between the other first and second contact areas is driven along the bridge plate. When operating the switch with a reversed current direction, the quenching behaviour will appear exactly the same, only then the arcs are each driven to the other quenching chamber or to the other bridge plate. In an alternative embodiment, the magnets in the switch are so arranged that the arc between the two first and the two second contact areas are driven by the magnetic field, with a particular current direction in the switch, respectively into the first quenching chamber or with reversed current flow respectively along the bridge deflector plates. Both variants are encompassed by the scope of protection of the invention. The expression “substantially” includes in the present invention all embodiments which deviate less than 10% from the prescribed value.

Here, the first and second contact areas designate the areas of the fixed contacts and of the movable contact which are in direct contact after closing the switch (ON state). In the ON state, a contact flows from one of the two first contacts through the first contact area into the second contact area in contact with it, from this through the electrically conductive bridge contact to the other second contact area of the bridge contact and from there through the other first contact area in contact with it into the other fixed contact. To that end, the first contacts, as well as the first and second contact areas and the bridge contact, consist of an electrically conductive material. For closing the contacts (ON state), the bridge contact with the second contact areas is moved onto the first contact areas. Here the first and second contact areas can be component areas of the fixed contacts or of the bridge contact, or separate components which are positioned on the fixed contacts or on the bridge contact. The abovementioned movement occurs along a movement axis of the bridge contact perpendicular to the surfaces of the contact areas. Here the bridge contact is fixed in a bridge device, preferably made of plastic, by means of a spring, which also generates the required contact pressure. In one embodiment, the movement axis is oriented perpendicular to the movement direction of the arc into the first quenching chamber. Opening of the switch is accomplished by moving the bridge contact in the opposite direction. The movement of the bridge contact can be accomplished manually or electrically. The first and second contact areas can differ in shape and in material. Here the surfaces of the first and second contact areas can vary between extended surfaces and dot-like contacts. The material of the contact areas can be any suitable electrically conductive material, for example silver tin oxide.

Here the first quenching chamber includes any type of component suited to bringing about the quenching of an arc. In one embodiment of the quenching chambers, these include a multitude of quenching plates between the first and a second arc deflector, which are both positioned in the quenching chamber parallel to one another. The magnets used, preferably permanent magnets, are used to generate a strong homogeneous magnetic field and to exert a force on the arc in the direction of the quenching chambers. For quickly quenching an arc, the Lorenz force is preferably exerted by the permanent magnets until it enters the quenching chamber. If there is sufficient space within the switch, it is consequently advantageous to locate the permanent magnets as close as possible to the quenching chambers, or even laterally above the quenching chambers. The quenching plates in the quenching chambers are for example V-shaped. The arc is subdivided into a multitude of partial arcs in the quenching chamber (deionization chamber). The minimum voltage then required to maintain the arc is proportional to the number of the quenching plates present in the quenching chamber, thereby raising the required voltage for maintaining the arc above the available voltage, which leads to quenching of the arc. The quenching plates are fixed in an insulating material to which the arc deflector plates are also fixed. Here the arc deflector plates can have any shape which is suitable for deflecting the arc into the quenching chambers. The arc deflector plates can also be implemented as stamped bent parts. The thickness and width of the arc deflector plates can also vary. The spacing between the first (lower) and the second (upper) arc deflector plate can then increase with increasing separation from the first and second contacts.

In one embodiment, the bridge plates each extend to the second contact site of the movable bridge contact. As the arc arises between the first and second contact areas when switching off, it is appropriate that the bridge plate reach close to the location of the arc in order to be able to effect a quick quenching by means of a quick deflection of the arc.

In one embodiment, the distance between the bridge plate and the back side of the fixed contact increases with increasing separation from the movement axis of the bridge contact. The arc path is thereby lengthened and consequently the voltage required to maintain the arc is increased. If the arc voltage exceeds the operating voltage of the switch, the arc is extinguished.

In one embodiment, the magnets and the bridge plate are so arranged that the magnetic field also extends into the area between the bridge plate and the fixed contact. Thereby, with the second current direction, the magnetic field drives the arc in the direction of the bridge plate and consequently accelerates the quenching of the arc.

In one embodiment, the magnet is so positioned that the field strength of the magnetic field between the first and second contact areas and between the bridge plates and the fixed contacts is substantially equal. The greater the magnetic field strength at the location of the arc, the more strongly the driving Lorenz force acts on the arc. For quickly quenching the arc with current flows in both directions it is advantageous that a strong magnetic field can operate in the movement path of the arc for both current directions.

In one embodiment, the magnet is a permanent magnet. A very strong permanent magnetic field can be supplied by a permanent magnet which for example is a rare-earth magnet. Rare-earth magnets consist for example of a NdFeB or SmCo alloy. These materials have a high coercivity and thereby also allow magnets to be made for example as very thin plates. The permanent magnets are then so positioned that they generate a substantially homogeneous magnetic field at least in the area of the first and second contacts, preferably along the arc deflector plates and the bridge plates. The elapsed time until the arc is driven into the quenching chambers or along the bridge plates depends on the magnetic field strength and the homogeneity of the magnetic field. To this end, the permanent magnets are preferably so arranged that they generate a magnetic field perpendicular to the current flow in the arc and perpendicular to the desired direction of motion of the arc, that is along the arc deflector plates and bridge plates. In one embodiment, the permanent magnet includes for this purpose two plate-shaped permanent magnets whose surfaces are arranged parallel to one another and which extend at least over the first and second contact areas parallel to the bridge contact and the first and second arc deflector plates and the first bridge plates, at least in the OFF state of the switch.

Hence, the permanent magnets are also positioned substantially parallel to the direction of motion of the movable bridge contact. The permanent magnets are preferably thin plates, as the available space inside the switch is limited. The distance between the oppositely positioned permanent magnets for generating a homogenous magnetic field can vary as a function of the magnetic material employed. Between the oppositely situated magnet surfaces are situated the first and second contact areas as well as at least portions of the movable bridge contact and the fixed contacts and at least portions of the arc deflector plates and bridge plates. In an additional embodiment, the magnetic circuit can be closed through a magnetic material bridge between the oppositely situated permanent magnets. For example, the separation between the permanent magnets can amount to about 8 mm with a given thickness and material of the permanent magnets in a switch for operation at 1500 V DC and currents of 30 A. As the switch is preferably constructed symmetrically, the magnet can, for the purpose of exerting a Lorenz force on the arc, be implemented as 4 permanent magnets in all, arranged as two pairs of e.g. flat plates in the area of the two respective first and second contact surfaces. In order to accomplish the preferred quenching of the two arcs between the two first and second contacts in one first quenching chamber each for the first arc and in the bridge plate or in the second quenching chamber for the other arc, the two pairs of permanent magnets must each generate a field with opposite field orientation. If the field orientation in both pairs of permanent magnets in another embodiment of the switch were the same, the arcs would either both be driven into the first quenching chambers or in the direction of the bridge toward the bridge plates or the second quenching chamber. Here a different geometric shape of the magnets can also be selected within the scope of the present invention.

In one embodiment, first arc deflector plates are each permanently fastened to the first contact areas. Consequently obstacles to the movement of the arc, such as air gaps for example, are avoided, at least for the fixed contacts.

In one embodiment, the bridge plates extend into at least one second quenching chamber, which is located on the movable bridge contact. Here the bridge plate operates as an arc deflector plate. The expression “located on the movable bridge contact” indicates here the possibility that the bridge contact and the quenching chamber are indirectly mechanically interconnected through the bridge device. The second quenching chamber can have similar or the same fundamental construction as the first quenching chamber. The size of the second quenching chamber can turn out smaller than that of the first quenching chamber due to the position of the second quenching chamber on the movable bridge contact. The bridge contact preferably includes two separate second quenching chambers, into which the respective the bridge plates extend.

In one embodiment, the fixed contacts each include a contact deflector plate which extends from the first contact area to the second quenching chamber. The arc is thereby, similarly to the first quenching chambers, led from the first contact area along an arc deflector plate, here the contact deflector plate of the first contact, to the second quenching chamber. This contact deflector plate of the first contact leads, with equal Lorenz force, to quicker transport of the arc into the second quenching chamber. Due to the presence of the second quenching chamber, the first quenching chamber can also be built more compactly, or smaller in other words.

In one embodiment, the second quenching chambers include quenching plates for quenching the arc which are arranged parallel to the axis of motion of the bridge contact. A small construction of the second quenching chamber is thereby made possible.

In one embodiment, the magnet extends to the second quenching chamber. Thus the driving magnetic force operates on the arc up to the point where it enters the quenching chamber, which further contributes to quick and reliable arc quenching.

Unlike prior art switches, the switch according to embodiments of the invention makes possible the rapid quenching of arcs in first and second quenching chambers or bridge plates, as the magnetic fields drive the arcs, particularly with strong permanent magnets, independently of the current direction in the switch, into one or the other quenching chamber or to the bridge plate. In addition, the bridge plates constitute thermal protection for the bridge device. In addition, the first arc deflector plate or the contact deflector plate of the first contact is directly connected with the first contact area, so that during movement of the arc into the first or second quenching chamber no obstructing barriers such as air gaps need to be bridged. The arrangement of the permanent magnets as parallel surfaces closely spaced to the first and second contact areas increases the driving Lorenz force on the arcs toward the quenching chambers. The quenching of arcs consequently occurs in a predetermined, reliable and quick manner independent of the direction of the current in the switch.

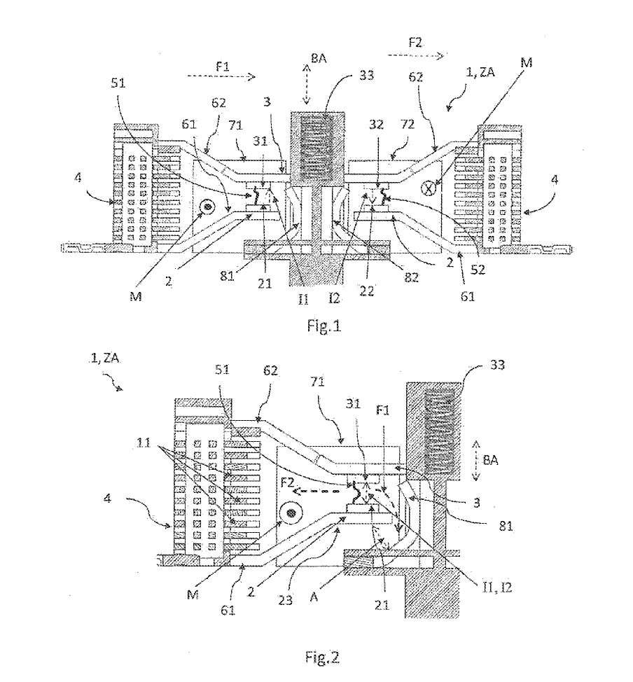

FIG. 1 and FIG. 2 show a cross-section through an embodiment of a switching chamber of a switch 1 according to the present invention. For the sake of clarity, the Figures are limited to the switching chambers of the switch. A switch naturally has other components, in addition to the switching chambers, which are known to a person skilled in the art. The switch 1 is suited by its construction to direct current operation independent of polarity. The entire switch is shown in a symmetrical embodiment in FIG. 1, while FIG. 2, for better understanding, shows the left-hand portion of the switch of FIG. 1 in an enlarged view. To that end, the switch 1 includes two separate fixed contacts 2, each with a first contact area 21, 22 and a movable electrically conductive bridge contact 3 with two second contact areas 31, 32, which are brought into contact with one another along the movement axis BA of the bridge contact for creating an electrically conductive connection between the first and second contact areas 21, 22, 31, 32 in the ON state of the switch 1. For separating the first and second contact areas 21, 22, 31, 32 in the OFF state of the switch 1, the bridge contact 3 is moved in the opposite direction along the movement axis BA, so that a separation occurs between the first and second contact areas 21, 22, 31, 32. In these separations, arcs 51, 52 can occur after switching off For the purpose of quenching them more reliably and faster, the switch 1 includes at least one magnet 71, 72, which is provided for the purpose of generating a substantially constant magnetic field M in the region of the first and second contact areas 21, 22, 31, 32 for exerting a magnetic force F1, F2 on an arc 51, 52 located between the first and second contact areas 21, 22, 31, 32. The field orientation of the magnetic field is shown in the left-hand portion of the figures by the circle M with a dark centre point (FIGS. 1 and 2) In this illustration, the field lines are leaving the sheet surface heading upward. In FIG. 1, the magnetic field orientation M is also shown for the right-hand portion of the switch 1 as a circle with a cross. In this illustration, the field lines are passing through the sheet surface heading downward. In the region of the plate-shaped magnets 71, 72, the field lines are substantially parallel to one another. For the sake of clarity, the magnets situated opposite the magnets illustrated are not shown, in order to allow a view of the contact sites and the arc deflection plates. In a complete switch, the magnets are always arranged in opposing pairs, in order to be able to generate a homogeneous magnetic field perpendicular to the current direction I1, I2 through the arcs and perpendicular to the arc deflector plates, contact deflector plates and bridge plates. Under the influence of this magnetic force F1, F2 (Lorenz force), in the preferred embodiment shown in FIG. 1, one arc 52 on the right side with current direction I2 is pushed by the force F2 in the direction of the first quenching chambers 4 and the other arc 51 on the left side with opposite current direction I1 is pushed by the force F1 in the direction of the bridge plate 81 for quenching the arcs 51, 52, as shown by the dashed arrows F1, F2 above the switching chamber. The current directions I1, I2 of the respective arcs are shown by the dashed arrows. With a reversed current direction, the left arc 51 was correspondingly driven into the left first quenching chamber 4 and the right arc 52 was driven toward the right bridge plate 82. The two possible movement directions of the arc 51 are shown in FIG. 2 by the arrows F1, F2 depending on the two current directions I1, I2 for a given magnetic field direction. Here force F1 operates on the arc 51 with current direction I1 and force F2 operates with current direction I2. In order that the arcs 51, 52 can each be quickly moved into the first quenching chamber 4, these are connected, at least in the OFF state of the switch 1, by means of a first arc deflector plate 61 with the first contact areas 21, 22, and by means of a second arc deflector plate 62 with the second contact areas 31, 32, or the arc deflector plates extend at least to the first and second contact areas. The expression “to extend” designates the condition wherein components are interconnected, or if applicable are positioned in proximity to one another, but are still separated by an air gap (spacing). In the case of the bridge plates, the expression “to extend” even designates in this example a substantially greater spacing, e.g. in the order of size of a few millimetres or more. Moreover, the movable bridge contact 3 includes two bridge plates 81, 82, which, for the purpose of quenching the arcs 51, 52, extend in a second direction opposite that of the first current direction from the bridge contact 3 along the displacement axis BA of the bridge contact, around each of the first contact areas 21, 22 to the back sides 23 of the fixed contacts 2 facing away from the bridge contact 3, provided that the current direction in the arc is the second current direction, which has the opposite orientation from the first current direction. Here, the arc is moved along the curved bridge plate and consequently describes a circular path around the fixed contact 2 and onto its back side 23. Due to the increased spacing A between the fixed contact 2 (back side 23) and the bridge plate 81, quenching of the arc is brought about, because once a certain spacing A is reached, the voltage needed for maintaining the arc 51 exceeds the operating voltage that is actually present.

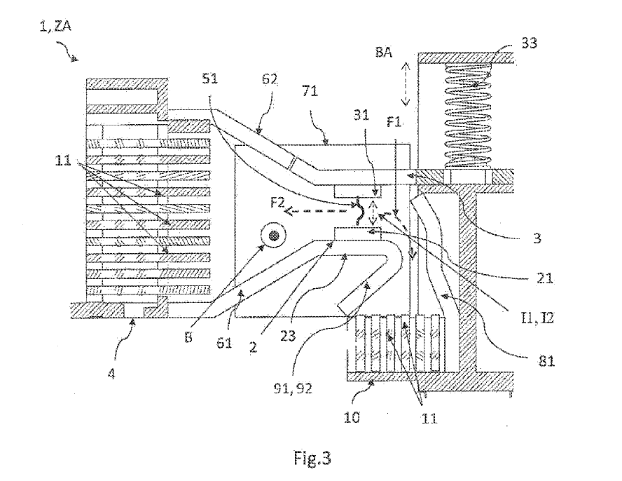

FIG. 3 shows a cross-section through another embodiment of a switch according to the present invention. Here the switch 1 is distinguished from FIGS. 1 and 2 by the configuration of the quenching path on the bridge contact 3. Here, the bridge plate 81 shown extends (the same applies for the other side of the switch correspondingly to the bridge plate 82) into a second quenching chamber 10, which is positioned on the movable bridge contact 3. In order for the arc 51 to be driven quickly and reliably by the magnetic field M into the quenching chamber 10, the fixed contacts 2 each include a contact plate 91, 92 which extends from the first contact area 21 to the second quenching chamber 10. In order to be able to locate the second quenching chamber 10 in a switch 1 while saving space, the quenching plates 11 of the second quenching chamber 10 are arranged parallel to the axis of motion BA of the bridge contact 3. For rapid quenching of the arc, it is advantageous in this connection for the magnet 71, 72 to extend to the second quenching chamber 10.

The detailed description of the invention in this section and in the figures is to be understood as an example of possible embodiments within the scope of the invention, and not in a limiting sense. In particular, indicated dimensions are to be adapted to the respective operating requirements of the switch (current, voltage) by a person skilled in the art. Consequently, all dimensions given are to be understood only as examples for specific embodiments.

Alternative embodiments, which a person skilled in the art may contemplate within the scope of the present invention, are also encompassed in the scope of protection of the present invention. In the claims, expressions such as “a,” “an” or “one” also include the plural. Reference symbols used in the claims are not to be construed as limiting.

### REFERENCE SYMBOL LIST

1 Switch according to the present invention
2 Fixed contact
21, 22 First contact areas
23 Back side of the fixed contacts
3 Movable bridge contact
31, 32 Second contact areas
33 Spring of the movable bridge contact
4 First quenching chamber
51, 52 Arcs
61 First arc deflector plate
62 Second arc deflector plate
71, 72 Magnets, preferably permanent magnets
81, 82 Bridge plates
91, 92 Contact deflector plates of the first contacts
10 Second quenching chamber
11 Quenching plate
A Spacing between the bridge plate and the fixed contact
BA Axis of motion of the movable bridge contact
I1, I2 Current directions in the arc
M Magnetic field
F1, F2 Lorenz force on the arc
ZA Open switch (OFF state)

1-12. (canceled)

13. A switch for polarity-independent direct current operation comprising:
at least two separated fixed contacts, each including a first contact area;
a movable electrically conductive bridge contact with two second contact areas configured to form an electrically conducting connection between the first and second contact areas in an ON state of the switch and to separate the first and second contact areas in an OFF state of the switch;
a magnet configured to generate a substantially constant magnetic field in a region of the first and second contact areas so as to exert a magnetic force on, an arc occurring between the first and second contact areas when the OFF state is generated;
at least two first quenching chambers for quenching arcs with a first current direction; and
a first arc deflector plate extending, at least in the OFF state, from each of the first quenching chambers toward the first contact area and a second arc deflector plate extending toward the second contact area for removing the arc into the first quenching chambers,
wherein the movable bridge contact includes first and second bridge plates which extend around each of the first contact areas to a back side of the fixed contacts facing away from the bridge contact, so as to quench arcs in a second direction opposite that of the first current direction from the bridge contact along a displacement axis of the bridge contact.

14. The switch according to claim 13, wherein the bridge plates each extend to the second contacts of the movable bridge contact.

15. The switch according to claim 13, wherein the spacing between the bridge plate and the back side of the fixed contact increases with increasing distance to the axis of motion of the bridge contact.

16. The switch according to claim 13, wherein the magnet and the bridge plate are arranged so as to extend the magnetic field into a region between the bridge plate and the fixed contact.

17. The switch according to claim 16, wherein the magnet is arranged so as to generate a field strength of the magnetic field between the first and second contact areas and between the bridge plates and the fixed contacts that is substantially the same.

18. The switch according to claim 13, wherein the magnet is a permanent magnet.

19. The switch according to claim 18, wherein the permanent magnet includes two plate-shaped permanent magnets, wherein surfaces of the plate-shaped permanent magnets are arranged parallel to one another and extend at least over the first and second contact areas parallel to the bridge contact and the first and second arc deflection plates and the first bridge deflection plates, at least in the OFF state of the switch

20. The switch according to claim 13, wherein each of the first arc deflector plates is firmly connected with the first contact areas.

21. The switch according to claim 13, wherein the bridge plates extend at least into a second quenching chamber that is positioned on the movable bridge contact.

22. The switch according to claim 21, wherein the fixed contacts each include a contact deflector plate, which extends from the first contact area to the second quenching chamber.

23. The switch according to one of claim 21, wherein the second quenching chamber includes quenching plates for quenching the arc, the quenching plates being arranged parallel to the axis of motion of the bridge contact.

24. The switch according to one of claim 21, wherein the magnet extends to the second quenching chamber,
